(19) United States
(12) Patent Application Publication
(10) Pub. No.: US 2013/0274800 A1
(43) Pub. Date: Oct. 17, 2013

(54) Spinal Column Correction Device

(71) Applicants: Robert J. Herman, Minnetrista, MN (US); Shelly R. Herman, Minnetrista, MN (US)

(72) Inventors: Robert J. Herman, Minnetrista, MN (US); Shelly R. Herman, Minnetrista, MN (US)

(21) Appl. No.: 13/824,550

(22) PCT Filed: Sep. 19, 2011
(86) PCT No.: PCT/US11/52153

§ 371 Date: Jun. 10, 2013

(30) Foreign Application Priority Data
Sep. 18, 2010 (US) 61403591
Jul. 28, 2011 (US) 61574204

(51) Int. Cl. A61H 1/00

(52) U.S. Cl. CPC A61H 1/008
USPC 606/240

(57) ABSTRACT

A spinal column corrective device is provided that includes an upper and lower portion joined by a connection area which may articulate, having an adjustment means and wider support area by which a device user can mirror a cervical radius, thoracic radius, lumbar radius and sacral radius, inherent in the device, with users spine for educational and wellness purposes.

### RELATED APPLICATION

This application claims the benefit of U.S. Provisional Application No. 61/403,591 filed on Sep. 18, 2010 and is related to U.S. Provisional Application No. 61/574,204 filed on Jul. 28, 2011, which are incorporated herein by reference.

### BACKGROUND OF THE INVENTION

The present application relates to spinal column corrective devices, in particular to corrective devices allowing the user to uniformly restore good posture by restoring proper bone alignment.

Your spinal column is one of the most important parts of your body, giving your body structure and support. Without the spine you cannot stand up or keep yourself upright. The spinal column allows you to move about freely, to bend with flexibility and is also designed to protect your spinal cord.

The spinal cord is a column of nerves that connects the brain to the rest of the body, allowing you to control movement of individual body parts. Without a healthy spinal cord you become disconnected from your body, the outer world, and your organs cannot function properly.

Keeping the spinal column healthy is vital if you want to live a happy and active life. Unfortunately, in most recent years modern life tends to consist of sedentary, hunched forward activities like working on the computer, driving cars, watching TV, and playing video games. These activities promote poor posture. The long term effect of poor posture can affect the entire body. Body systems such as digestion, elimination, breathing, muscles, joints and ligaments are adversely affected. A person who has poor posture may often be tired, unable to work efficiently, suffer from pain or even unable to move properly.

Many abnormal spinal column postures develop from modern life. The most common abnormal posture is called Forward Head Posture (FHP), which is defined as the forward positioning of the neck and head. Hunching and rounding of the shoulders and a curved upper back are consequently associated with this posture.

Many systems of spinal rejuvenation, in addition to Chiropractic treatment, have been devised to correct spinal column posture. Essentially, these systems consist of weights and cords attached to the neck or head. The purpose being to affect the muscle tissue that supports and maintains spinal curves. The problem with these systems is that they are often times difficult to use and put the user at possible risk of further injury or even potential strangulation, if inadvertently misused. Other devices, such has those made from various types of foam materials and inflatable means generally come in multiple sections and tend to misalign, easily discouraging a person from, most needed, regular use.

Accordingly there is a need for a spinal column corrective device which overcomes the limitations of the devices noted above and allows a user to uniformly restore good posture by restoring proper bone alignment.

### SUMMARY OF THE INVENTION

In at least one embodiment, a spinal column corrective device is provided that comprises a substantially rigid sheet like structure, the structure having a plurality of compound curves including at least two of a cervical curve, a thoracic curve, a lumbar curve and a sacral curve.

In at least one embodiment, the structure comprises an upper portion and a lower portion adjustably joined to the upper portion.

In at least one embodiment, at least one of the upper portion and the lower portion include a plurality of slots that allow the upper and lower portions to be adjusted lengthwise between a top end and a bottom end of the device.

In at least one embodiment, the upper portion has a generally rectangular shape in a plan view and a width, and the lower portion has a width greater than the width of the upper portion.

In at least one embodiment, the lower portion has a generally rectangular shape in plan view with left and right sides that extend outward from the lower portion therewith providing a support area that stabilizes the device when being used.

In at least one embodiment, the cervical curve has a radius of about 1.125 inches.

In at least one embodiment, the thoracic curve has a height of about 1.9 inches.

In at least one embodiment, the lumbar curve has a height of about 2.2 inches.

In at least one embodiment, the sacral curve has a radius of about 11.0 inches.

In at least one embodiment, the structure has a sheet thickness of about 0.125 inches.

Additional aspects of the present invention will be apparent in view of the description which follows.

### BRIEF DESCRIPTION OF THE FIGURES

FIG. 1 is a perspective view of one side and the top of the Spinal Column Corrective Device according to one embodiment of my invention;

FIG. 2 is a top view thereof;

FIG. 3 is a left side view thereof;

FIG. 4 is a right side view thereof;

FIG. 5 is a bottom view thereof;

FIG. 6 is a front view thereof; and

FIG. 7 is a back view thereof.

FIG. 8 is a perspective view of one side and the top of another embodiment of my invention;

FIG. 9 is a top view thereof;

FIG. 10 is a left side view thereof;

FIG. 11 is a right side view thereof;

FIG. 12 is a bottom view thereof;

FIG. 13 is a front view thereof; and

FIG. 14 is a back view thereof.

FIG. 15 is a lateral view of an embodiment of my invention in use.

FIG. 16 is a plan view of an element, of an embodiment, of my invention.

FIG. 17 is a side view of FIG. 16.

FIG. 18 is a plan view of another element, of an embodiment, of my invention.

FIG. 19 is a side view of FIG. 18.

FIG. 20 is yet, a perspective view of another embodiment of my invention.

### DETAILED DESCRIPTION OF THE INVENTION

The purpose of at least one embodiment of the spinal column corrective device 30 is to provide relief from back and or neck pain and improve posture. Another purpose of at least one embodiment of a spinal column corrective device 30 is to guide curves of the cervical, thoracic, lumbar and sacrum portions of the spinal column into their normal shape and position. Another purpose of at least one embodiment of a spinal column corrective device 30 is to loosen tight muscles and improve muscle and ligament alignment. A spinal column corrective device 30 works and supports the full spine at the same time. The device 30 may be adjustable to accommodate different torso lengths and provide a custom fit for the spinal column corrective device 30 user 52. Results are obtained gradually and safely by the use of body weight and gravity, without the need for potentially harmful pulling.

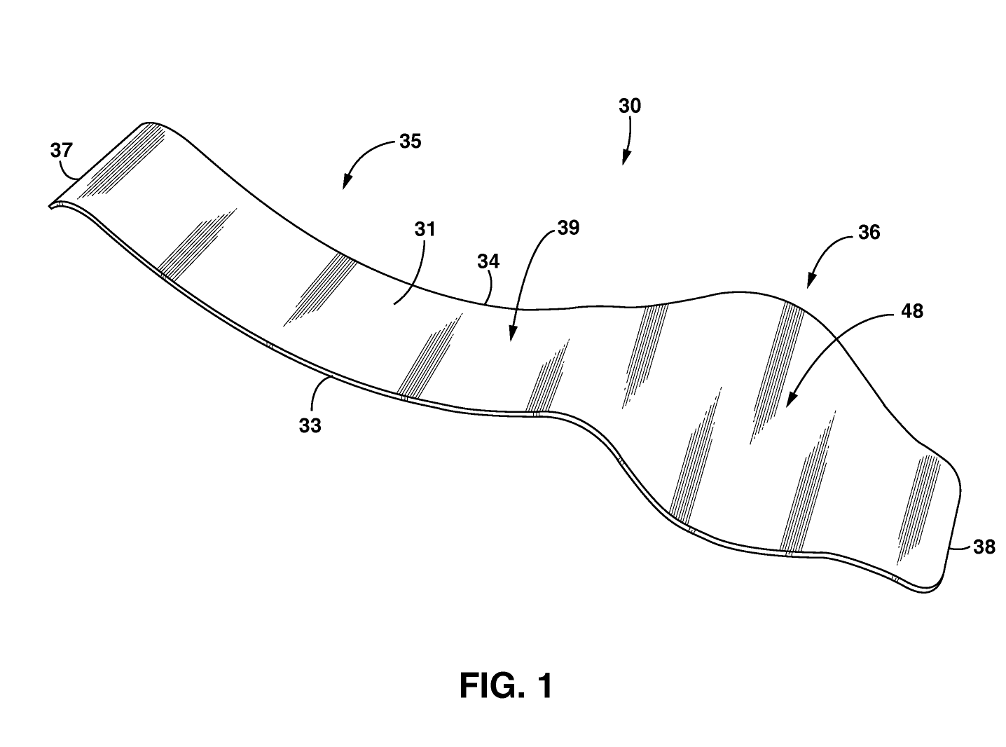

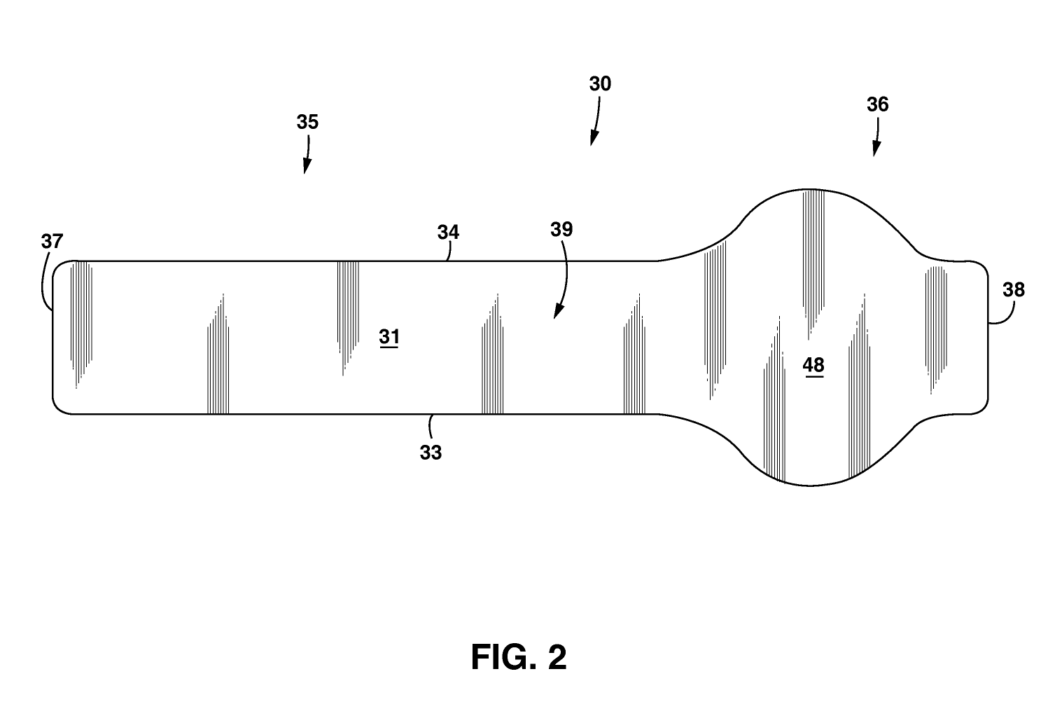

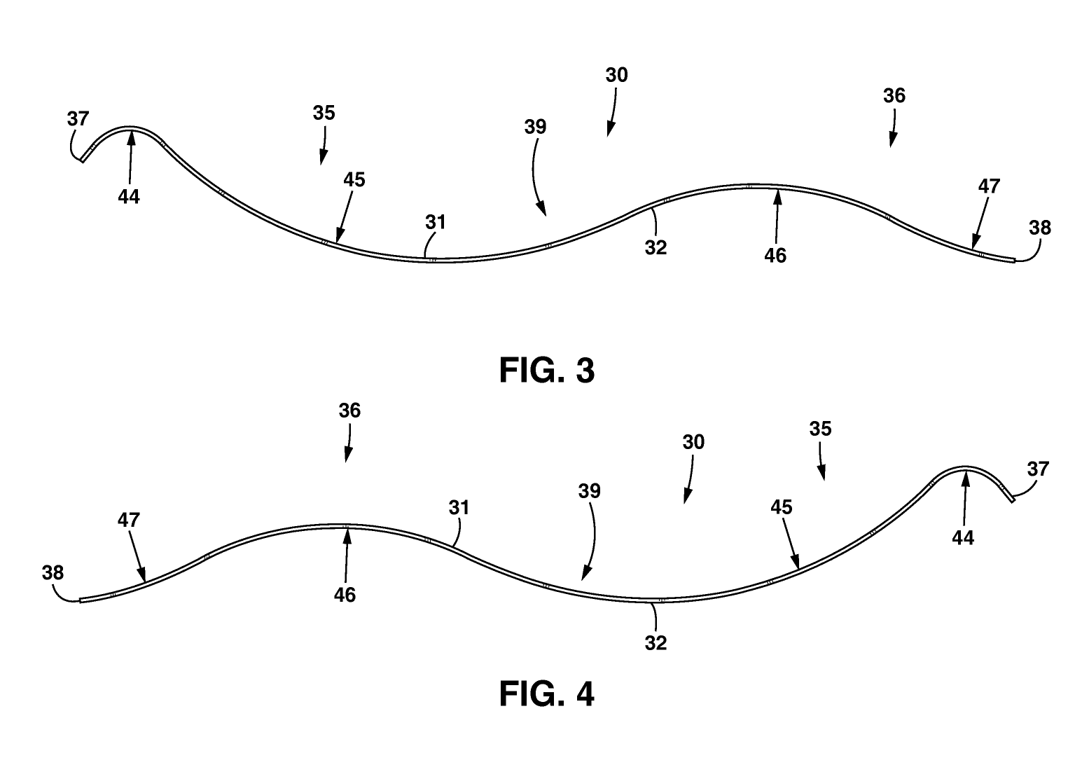

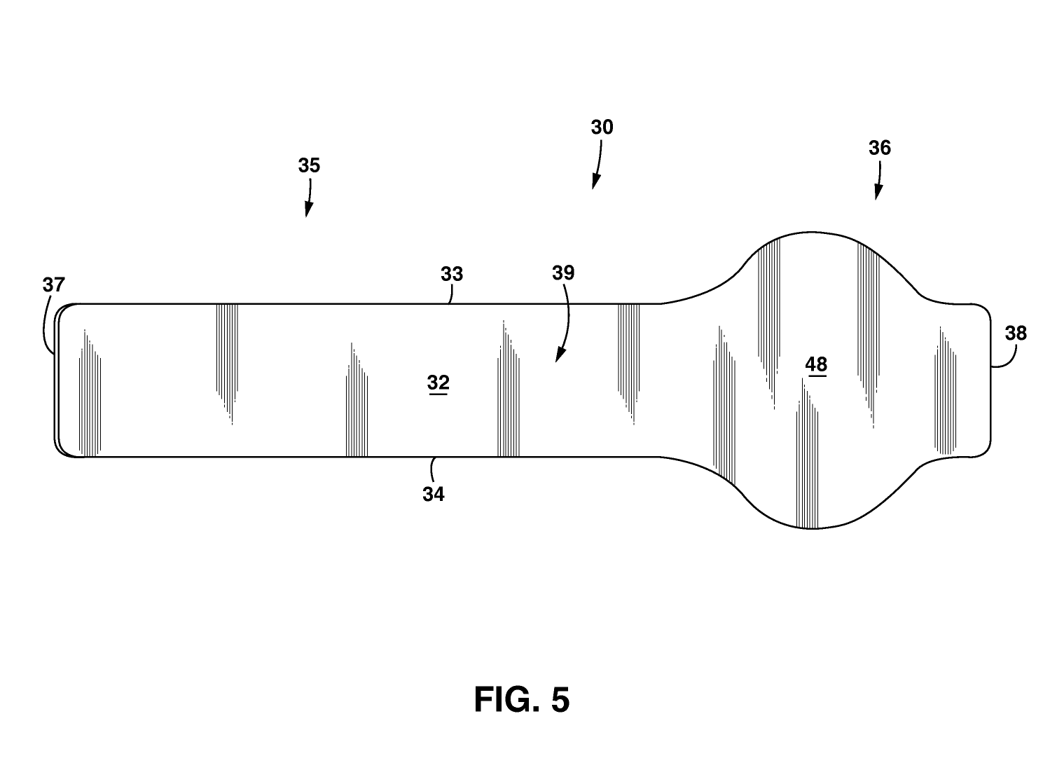

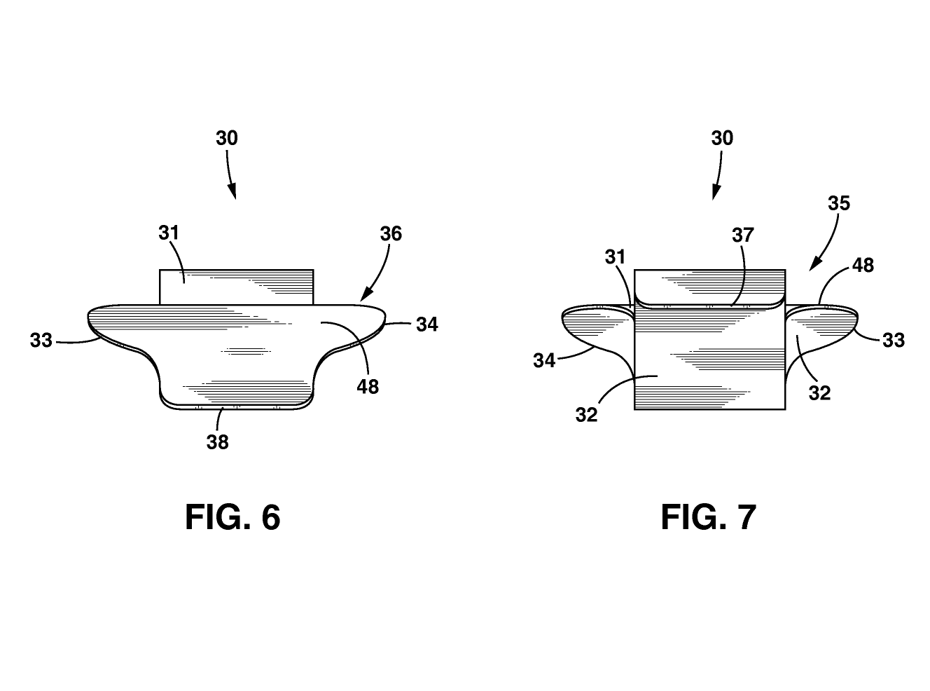

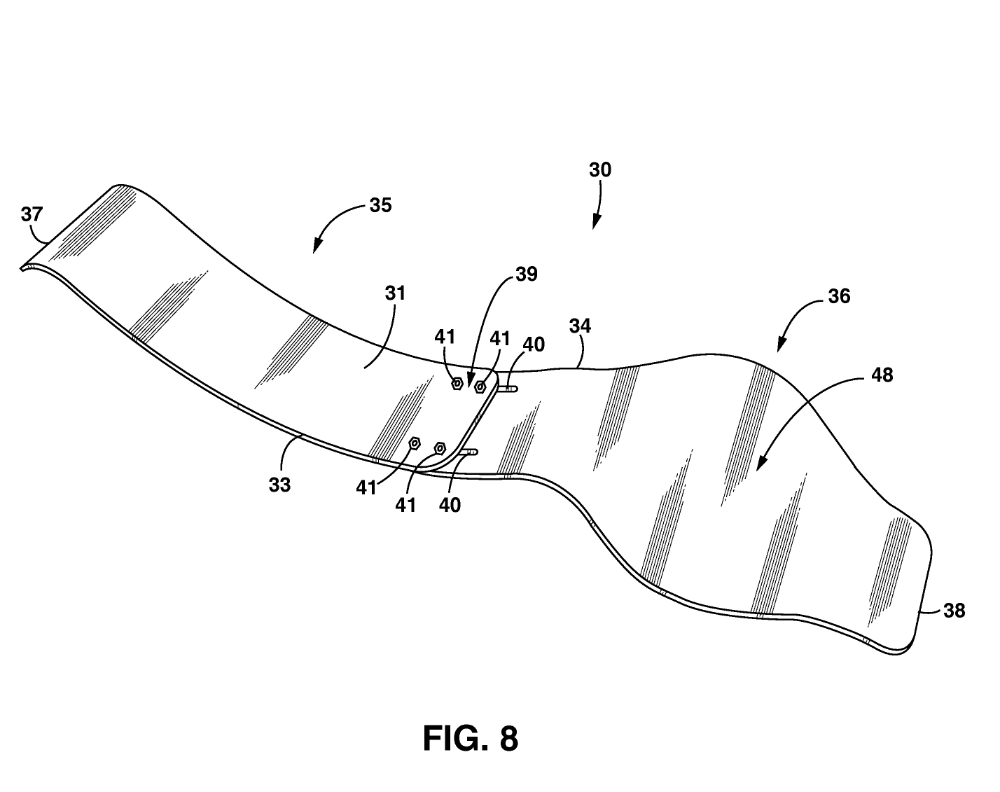

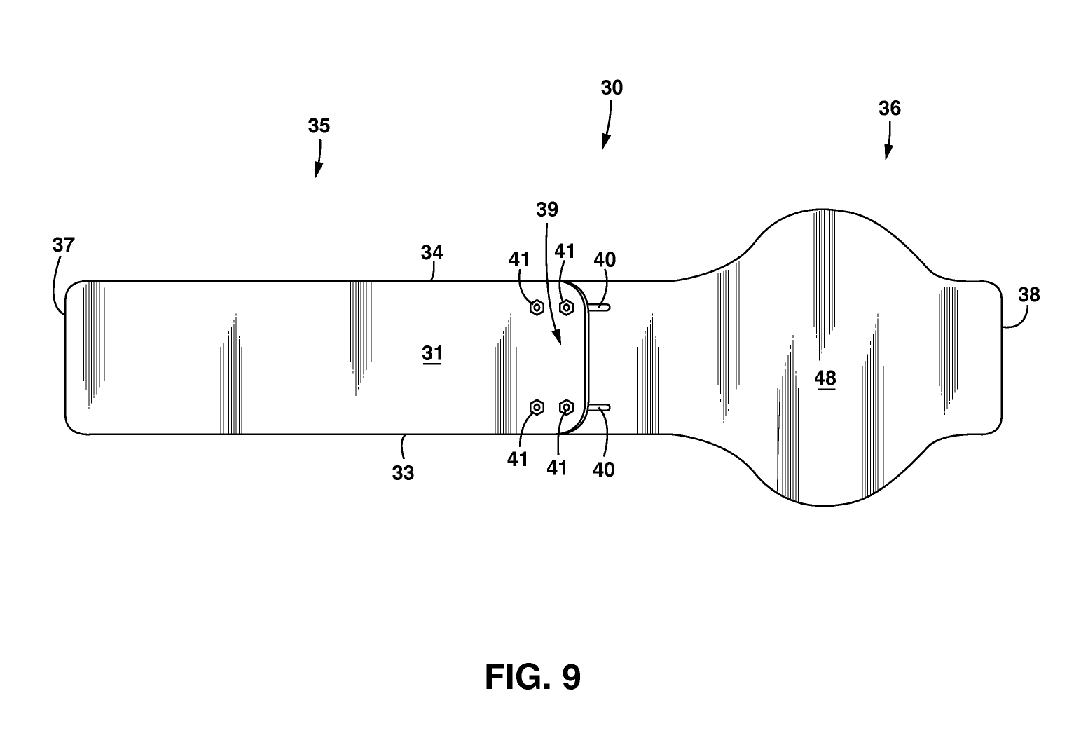

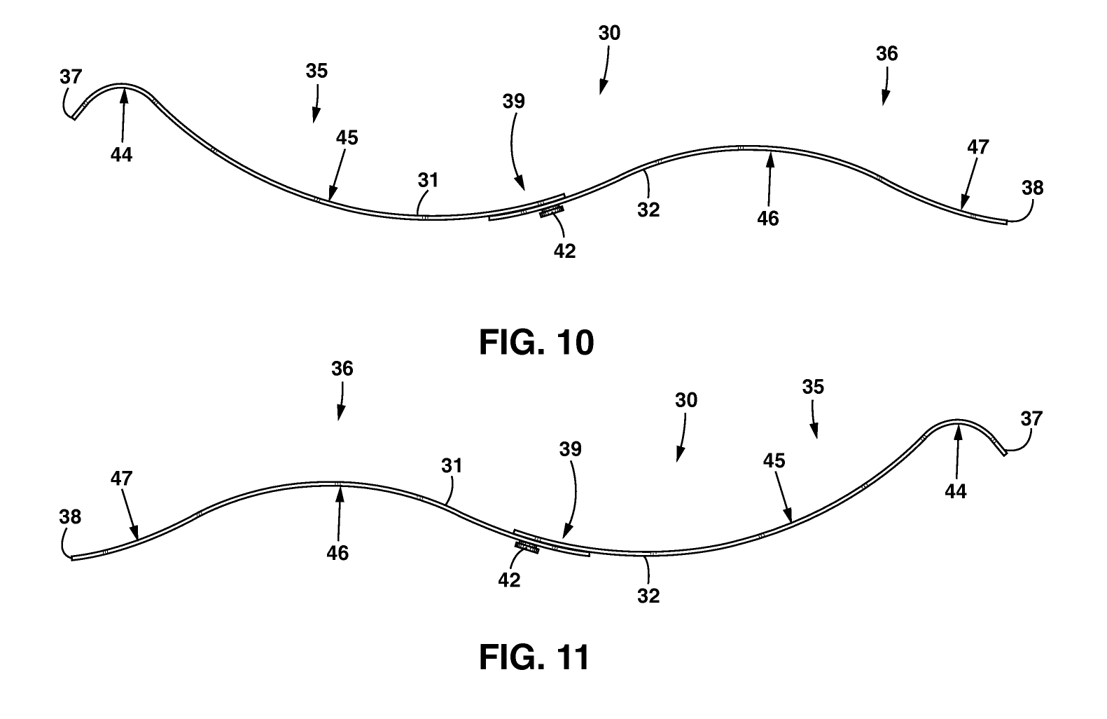

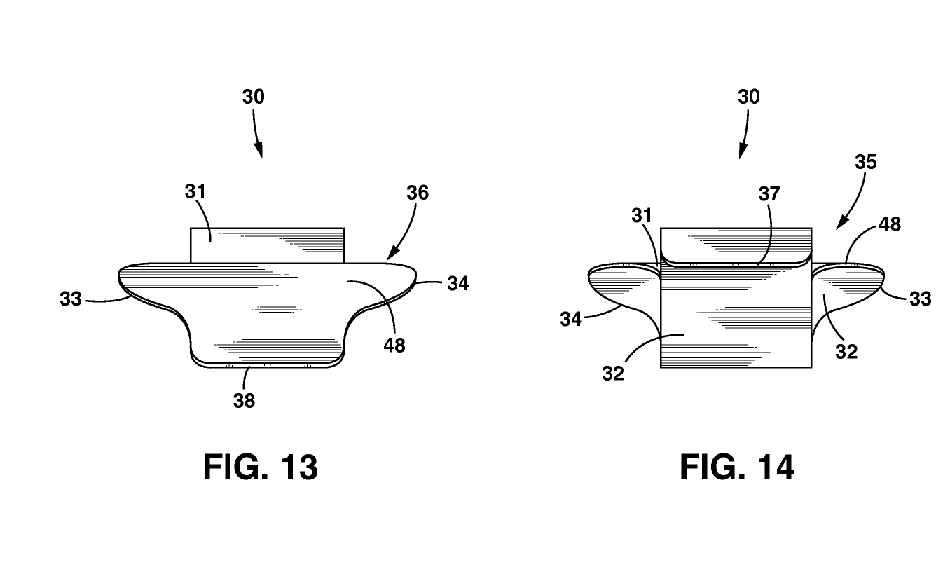

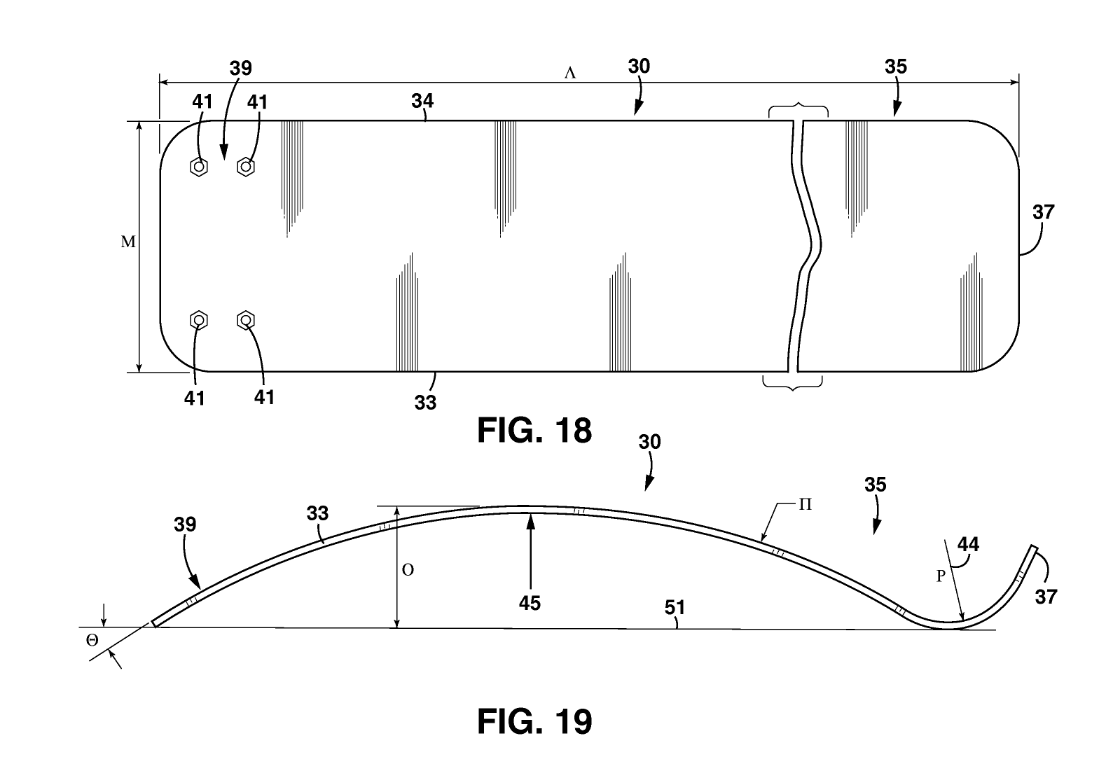

Referring to FIG. 1 through FIG. 20. A spinal column corrective device 30 is comprised of a sheet like structure having a top surface 31 and a bottom surface 32. The device 30 is formed into an upper portion 35 and a lower portion 36, having a left side 33 and a right side 34. A connection area 39 joins upper portion 35 and lower portion 36. A spinal column corrective device 30 can be manufactured in one, two or more pieces, as shown in FIG. 1 and FIG. 8.

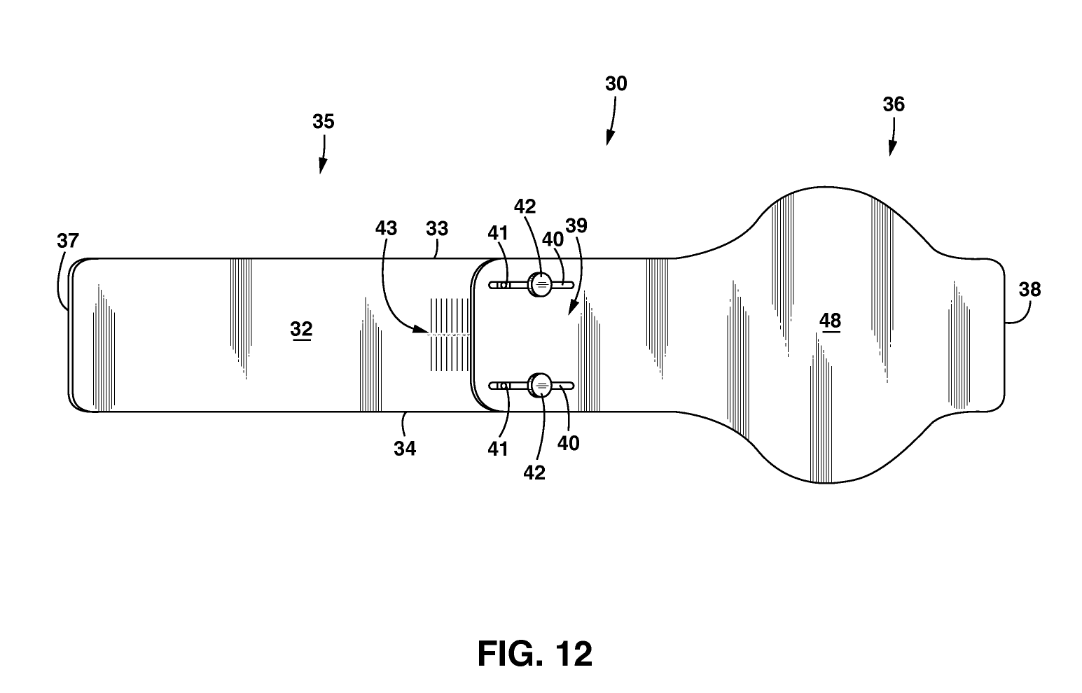

In one embodiment of the spinal corrective device 30 a connection area 39 contains one or more slots 40, connectors 41 and fasteners 42. The purpose of these elements is to form an articulating joint of which a controlled setting can be made by alignment of the adjustment means 43 located on bottom surface 32. In one embodiment, the adjustment means includes a plurality of marks that are aligned with the lower portion 36 as shown in FIG. 12.

A spinal column corrective device 30 is made by forming the device 30 to include a set of compound curves, including a cervical radius 44, thoracic radius 45, lumbar radius 46 and sacral radius 47, as shown in FIGS. 4-5 and 10-11. The device 30 may include a wider support area 48 is cut in the location of lower portion 36. The purpose of the wider support area 48 is to act as a stabilizing element when being used by creating more contact area with the sacral area of the body. This inhibits a spinal column corrective device 30 from side to side tipping and increases comfort for the user.

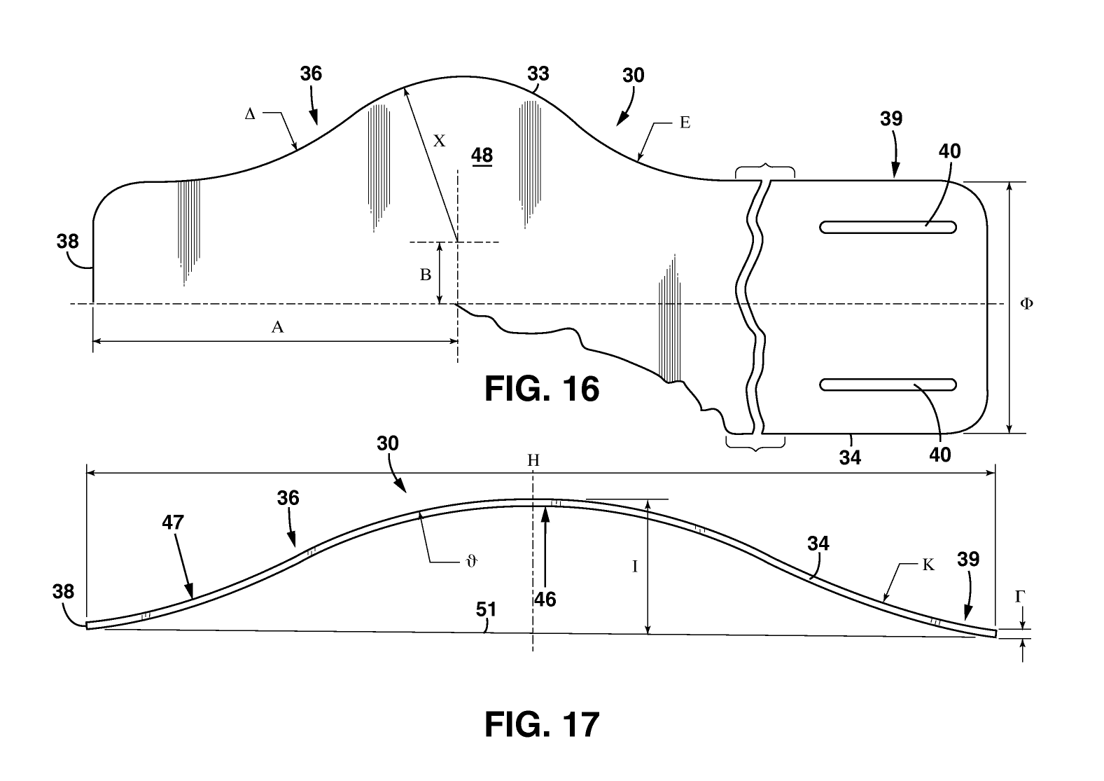

Referring, in particular, to FIG. 16 through 19. One embodiment is disclosed with preferred dimensions as follows. A=6.0 inches (flat dimension), B=1.0 inch, X=2.75 inches radius, Δ=5.0 inches radius, E=3.5 inches radius, Φ=4.0 inches, Γ=0.125 inches, H=15.0 inches (flat dimension), 14.3 (formed dimension), I=2.2 inches, θ=8.4 inches radius, K=11.0 inches radius, Λ=15.0 inches (flat dimension), 13.9 inches (formed dimension), M=4.0 inches, O=1.9 inches, Π=11.0 inches radius, Θ=32 degrees (reference dimension), P=1.25 inches radius. More specifically, a cervical radius 44=1.125 inches, thoracic radius 45=11.0 inches, lumbar radius 46=8.4 inches and sacral radius 47=11.0 inches. These dimensions are disclosed not to limit the invention but to disclose a particular embodiment. The dimensions could actually be within a range plus 20 percent of the disclosed dimensions and minus 10 percent of the disclosed dimensions.

A spinal column corrective device 30 can be constructed of metal, plastic, fiberglass, carbon fiber or any other material that holds a rigid shape with some flexibility or spring back qualities. In a particular embodiment, the material can be 0.125 inch thick 6061 series aircraft grade aluminum sheet with an anodized surface treatment.

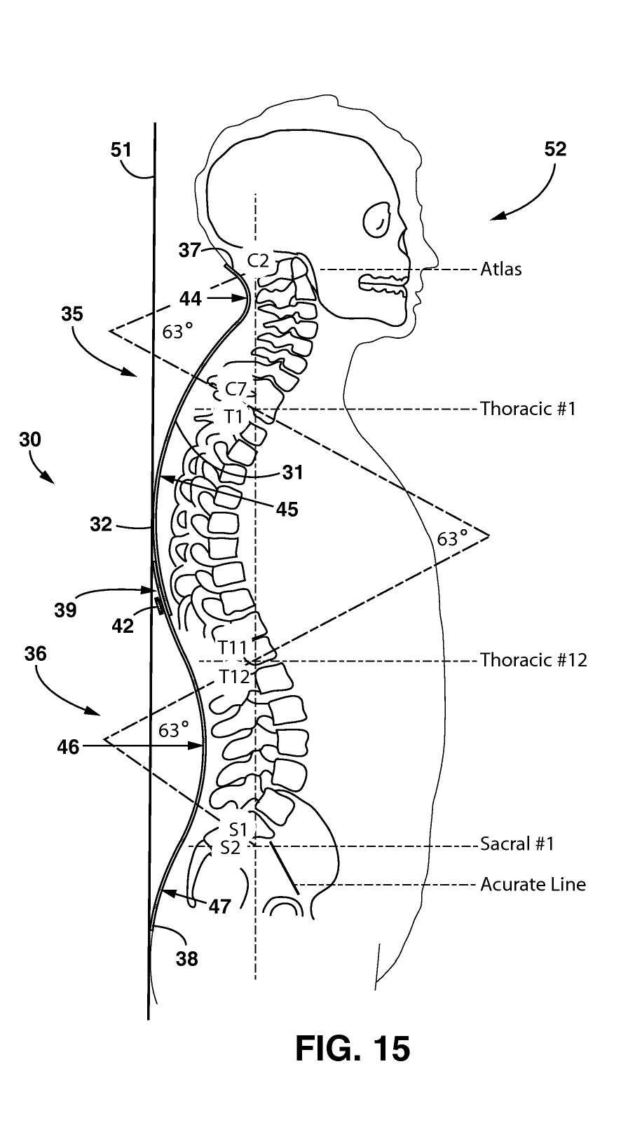

Referring to FIG. 15 a lateral view of an embodiment of my invention in use. A spinal column corrective device 30 mirrors the curvature of the proper shape of a spinal column. In this figure, the primary and secondary spinal curves, of a normal spinal model, are depicted as 63 degree arcs of circles of different radii. To eliminate any abnormal Z-axis translations (anterior-posterior movements), the following points are aligned with planar reference 51: 1) posterior-superior lateral mass of atlas, 2) posterior-inferior thoracic #1, 3) posterior-superior thoracic #12, and posterior-inferior sacral #1. The arcuate line (pelvic plane) is 60 degrees to horizontal, and the bite line of the skull is horizontal. The atlas plane would be ½ (63) or 31.5 degrees to horizontal. Planar reference 51 is shown in its vertical mode. Planar reference 51 is primarily vertical when used to evaluate a users spinal column. Planar reference 51 is primarily horizontal when used to correct a users 52 spinal column. Therefore, FIG. 15 can be understood to depict the vertical or horizontal mode of use of a spinal column corrective device 30.

The device user 52, desirous of back and or neck pain relief or spinal column correction, lines the curves of the cervical, thoracic, lumbar and sacrum portions of a spinal column corrective device 30 up to their own spine. In one embodiment they may adjust the length of a spinal column corrective device 30 to their spine. Then, by simply laying down on a spinal column corrective device 30, for a brief period of time such as two to five minutes increasing the time up to 20 minutes a session, the user retrains the abnormal spine to normal over a period of time.

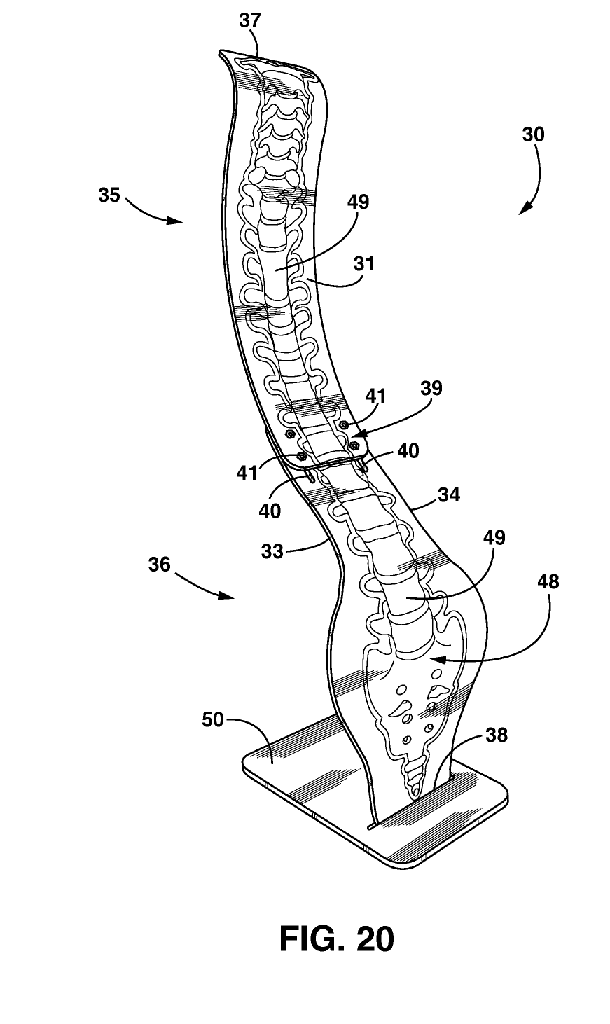

FIG. 20 illustrates one means of vertically mounting a spinal column corrective device 30 by placing it in a stand 50 constructed of a flat sheet material such as A-36 mild steel approximately 0.25 inch thick with protective pads on the bottom surface. A spinal column corrective device 30 may also be mounted by any means to a vertical surface such as a wall. A graphic 49 may be applied to any surface of a spinal column corrective device 30. In this view, a graphic 49 is depicted of a spinal column. The use of this graphic 49 is for educational purpose to assist the user 52 to understand the relationship of the spinal curves to the human body and a spinal column corrective device 30.

Therefore, a spinal column corrective device 30 can be of significant educational and wellness use at home or in a medical office.

While the foregoing has been described in some detail for purposes of clarity and understanding, it will be appreciated by one skilled in the art, from a reading of the disclosure, that various changes in form and detail can be made without departing from the true scope of the invention.

What is claimed is:

1. A spinal column corrective device comprising a substantially rigid sheet like structure, the structure having a plurality of compound curves including at least two of a cervical curve, a thoracic curve, a lumbar curve and a sacral curve.

2. The device of claim 1, wherein the structure comprises an upper portion and a lower portion adjustably joined to the upper portion.

3. The device of claim 2, wherein at least one of the upper portion and the lower portion include a plurality of slots that allow the upper and lower portions to be adjusted lengthwise between a top end and a bottom end of the device.

4. The device of claim 2, wherein the upper portion has a generally rectangular shape in a plan view and a width, and the lower portion has a width greater than the width of the upper portion.

5. The device of claim 4, wherein the lower portion has a generally rectangular shape in plan view with left and right sides that extend outward from the lower portion therewith providing a support area that stabilizes the device when being used.

6. The device of claim 1, wherein the cervical curve has a radius of about 1.125 inches.

7. The device of claim 1, wherein the thoracic curve has a height of about 1.9 inches.

8. The device of claim 1, wherein the lumbar curve has a height of about 2.2 inches.

9. The device of claim 1, wherein the sacral curve has a radius of about 11.0 inches.

10. The device of claim 1, wherein the structure has a sheet thickness of about 0.125 inches.
